(19) United States
(12) Patent Application Publication
(10) Pub. No.: US 2007/0126601 A1
(43) Pub. Date: Jun. 7, 2007

(54) SYSTEM AND METHOD FOR REPORTING REGULATION VIOLATION ITEM OF VEHICLE

(76) Inventor: Jeong Hyun PARK, Icheon-si (KR)

Correspondence Address: IPLA P.A., 3580 WILSHIRE BLVD., 17TH FLOOR, LOS ANGELES, CA, 90010, US

(21) Appl. No.: 11/549,595

(22) Filed: Oct. 13, 2006

(30) Foreign Application Priority Data
Oct. 14, 2005 (KR) 10-2005-0096834

(51) Int. Cl. G08G 1/01; G08B 1/00

(52) U.S. Cl. 340/936; 340/531

(57) ABSTRACT

Provided is a system and method for reporting a regulation violation of a vehicle. The system includes a sensor, a competent authority server, a vehicle database, a relay, and a vehicle terminal. The sensor senses the regulation violation of the vehicle. The competent authority server reads sense information received from the sensor, issues a penalty notice, and transmits regulation violation information to the violation vehicle. The vehicle database stores a variety of information relating to the vehicle. The relay wire/wireless connects with the competent authority server and at the same time, wireless connects with the vehicle terminal. The vehicle terminal is installed in the vehicle, and receives the regulation violation information from the competent authority server and transmits the received regulation violation information to a driver.

### CROSS REFERENCE

Applicant claims foreign priority under Paris Convention and 35 U.S.C. § 119 to a Korean Patent Application No. 10-2005-0096834, filed Oct. 14, 2005 with the Korean Intellectual Property Office.

### BACKGROUND OF THE INVENTION

1. Field of the Invention

The present invention relates to a system and method for reporting a regulation violation item of a vehicle to a driver, and more particularly, to a system and method for visually and aurally transmitting the regulation violation item of the vehicle to the driver at the time of violating traffic regulations, using a car audio or an audio/video (A/V) system installed in the vehicle.

2. Description of the Related Art

As a vehicle increases by geometric progression, a traffic accident problem is appearing as more serious social problem, together with a traffic congestion problem. A main cause of increasing traffic accidents is a violation of traffic regulations, such as a speed violation, a signal violation, a lane violation, a pause violation, and a parking and stop violation.

Specially, unlike other traffic regulation violations, the speed violation needs to be under more strict enforcement because there is a high possibility in which, when a traffic accident occurs in overspeed driving, it can succeed an irrevocable large traffic accident.

Accordingly, a police station being a traffic regulations enforcement agency installs an automatic enforcement equipment such as a mobile or fixed overspeed sensor camera everywhere on a road, detects an overspeed vehicle, imposes a penalty on the detected vehicle, and promote consciousness to the violation driver, thereby striving for recurrence prevention.

However, when the driver violates the traffic regulations by overspeed, a penalty notice is issued and addressed to a car owner after the lapse of a predetermined time period. Therefore, when the car owner does not receive the penalty notice due to a change of his/her address or does not frequently remember a fact of the overspeed, there occurs a public grievance for contending as to the provisional seizure or the overspeed violation of the vehicle.

In case where the driver unconsciously commits a speed violation in course of driving the vehicle, he/she keeps driving by overspeed as being ignorant of the speed violation. Thus, there is a drawback in that a probability in which the traffic accident occurs increases.

### SUMMARY OF THE INVENTION

Accordingly, the present invention is directed to a system and method for reporting a regulation violation item of a vehicle that substantially overcomes one or more of the limitations and disadvantages of the conventional art.

One object of the present invention is to provide a system and method for reporting a regulation violation item of a vehicle, for, when the running vehicle violates traffic regulations by overspeed, sensing the overspeed by an automatic speed sensor camera, reporting violation information to a police station, reading, by the police station, the violation information, automatically issuing a penalty notice, and transmitting the violation information to the overspeed vehicle using a wireless communication, and visually and aurally receiving and transmitting, by the overspeed vehicle, the violation information to a driver using a driver recognizer such as a car audio or an audio/video (A/V) system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a system for reporting a regulation violation of a vehicle. The system includes a sensor, a competent authority server, a vehicle database, a relay, and a vehicle terminal. The sensor senses the regulation violation of the vehicle. The competent authority server reads sense information received from the sensor, issues a penalty notice, and transmits regulation violation information to the violation vehicle. The vehicle database stores a variety of information relating to the vehicle. The relay wire/wireless connects with the competent authority server and at the same time, wireless connects with the vehicle terminal. The vehicle terminal is installed in the vehicle, and receives the regulation violation information from the competent authority server and transmits the received regulation violation information to a driver.

In another aspect of the present invention, there is provided a method for reporting a regulation violation of a vehicle. The method includes steps of, in a sensor, sensing and transmitting a regulation violation of a specific vehicle to a competent authority server; in the competent authority server, receiving and reading regulation violation sense information; in the competent authority server, automatically issuing a penalty notice depending on its regulation violation decision content; in the competent authority server, transmitting regulation violation information data to the vehicle terminal; and in a vehicle terminal, receiving the regulation violation information data, and aurally or visually transmitting the received information data to a driver.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a schematic diagram illustrating a construction of a whole system according to the present invention;

FIG. 2 is a detailed diagram illustrating a construction of a whole system according to the present invention;

FIG. 3 is a flowchart illustrating a method for sensing and reporting a regulation violation according to the present invention; and

FIG. 4 is a flowchart illustrating a method for receiving and transmitting violation information in a vehicle terminal according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

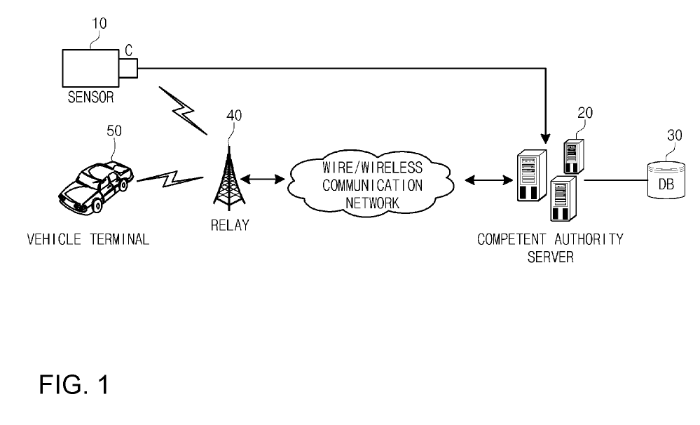

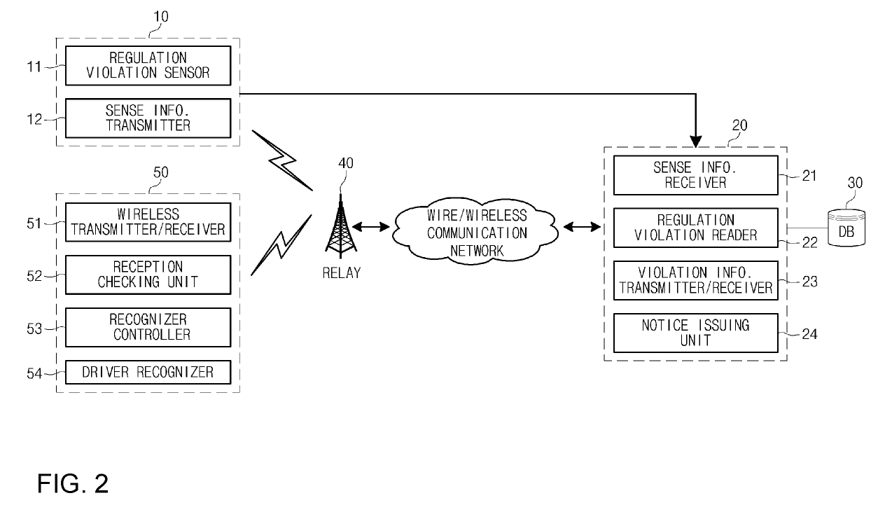

FIG. 1 is a schematic diagram illustrating a construction of a whole system according to the present invention. FIG. 2 is a detailed diagram illustrating the construction of the whole system according to the present invention. The inventive system includes a sensor 10 for sensing a regulation violation of a vehicle; a competent authority server 20 for reading sense information received from the sensor 10, issuing a penalty notice, and transmitting regulation violation information to the violating vehicle; a vehicle database 30 for storing a variety of information relating to the vehicle; a relay 40 wire/wireless connecting with the competent authority server 20 and at the same time, wireless connecting with a vehicle terminal 50; and the vehicle terminal 50 installed in the vehicle, and receiving the regulation violation information from the competent authority server 20 and transmitting the regulation violation information to a driver.

As shown in detail in FIG. 2, the sensor 10 includes a regulation violation sensor 11 for sensing a traffic regulation violation of the vehicle and at the same time, storing vehicle information; and a sense information transmitter 12 for transmitting a traffic regulation violation content and the vehicle information to the competent authority server 20, using a wire/wireless communication network or a dedicated line. The regulation violation sensor 11 preferably employs a fixed enforcement camera and a mobile enforcement camera, which are now managed, for sensing a speed violation and a signal violation.

According to another exemplary embodiment of the present invention, the sensor 10 can be constructed using a personal terminal 50 such as a portable digital assistant (PDA), which is convenient in its carriage and movement and enables a wireless data transmission, so that, when even a parking violation is detected other than the speed violation and the signal violation, a detected violation item can be reported to a competent authority.

As shown in detail in FIG. 2, the competent authority server 20 further includes a sense information receiver 21, a regulation violation reader 22, a violation information transmitter/receiver 23, and a notice issuing unit 24.

The sense information receiver 21 receives data including the traffic regulation violation content and the vehicle information from the sensor 10. The sense information receiver 21 has a function of receiving data from the mobile enforcement camera and the PDA in addition to a function of receiving data from the fixed enforcement camera being managed at present.

The regulation violation reader 22 reads a traffic regulation violation item of a specific vehicle from the sensor 10. The regulation violation reader 22 recognizes, by character, a vehicle number plate photographed by the enforcement camera, using an image processing software(s/w) of a main computer installed in the competent authority like the police station. The regulation violation reader 22 compares the character-recognized number plate with data of the vehicle information database 30, searches the data, and analyzes speed data and the like, thereby reading the vehicle information, the regulation violation or not, and a kind of the regulation violation.

The vehicle information and the regulation violation content read by the regulation violation reader 22 are again transmitted to and stored in the vehicle information database 30.

When the read result of the regulation violation reader 22 is decided to be the traffic regulation violation, the notice issuing unit 24 reads the vehicle information and issues the penalty notice.

The violation information transmitter/receiver 23 transmits information on the violation item that is decided on the basis of the read result of the regulation violation reader 22, to the violation vehicle through the relay 40. The information data is exemplified as a data signal, which is comprised of a voice and character notification message including a violation content corresponding to a kind of the decided violation, a violation date and time, a violation place, a penalty content, and a written advise.

The violation information transmitter/receiver 23 receives a reply signal including a reception check message from the violation vehicle.

As shown in detail in FIG. 2, the vehicle terminal 50 further includes a wireless transmitter/receiver 51 for receiving traffic regulation violation item information from the competent authority server 20 and at the same time, again transmitting the reception check message to the competent authority server 20; a reception checking unit 52 for generating the reception check message; a recognizer controller 53 for controlling a driver recognizer 54 to transmit the traffic regulation violation item information received through the wireless transmitter/receiver 51, to the driver; and the driver recognizer 54 for visually and aurally transmitting the traffic regulation violation item information to the driver under the control of the recognizer controller 53.

The driver recognizer 54 refers to a car audio or an audio/video (A/V) system installed in the vehicle. The driver recognizer 54 receives a voice signal based on the traffic regulation violation item information through an external interface terminal (not shown) using the recognizer controller 53. The driver recognizer 54 outputs the voice signal to a speaker through a sound controlling volume integrated circuit (IC) and a power amplifier (not shown) of the car audio or its corresponding A/V system.

The driver recognizer 54 receives a character output signal based on the traffic regulation violation item information, and displays its content by character, using a display unit of the car audio or the A/V system.

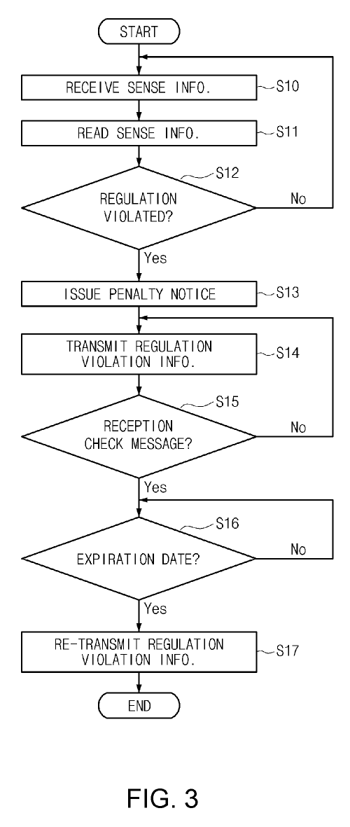

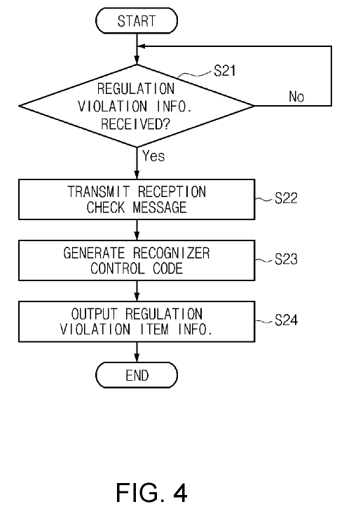

An operation of the present invention will be in detail described with reference to FIGS. 3 and 4.

FIG. 3 is a flowchart illustrating a method for sensing and reporting the regulation violation according to the present invention. The sensor 10, which is fixed and installed everywhere on a road or carried and moved by an enforcement officer, senses or detects the violation vehicle in course of monitoring vehicles within its monitoring area, and transmits the vehicle information. If so, the competent authority server 20 receives the vehicle information from the sensor 10 through the transmission line or the wire/wireless communication network including the relay 40 connecting up to the sensor 10 (Step 10).

After that, the regulation violation reader 22 reads the sense information (Step 11), and determines whether or not the sensed vehicle violates the traffic regulations (Step 12). When it is determined to violate the traffic regulations in the Step 12, the notice issuing unit searches the vehicle database 30 for a vehicle owner and a vehicle location, and issues the penalty notice (Step 13).

At the same time, the violation information transmitter/receiver 23 generates the violation item information of the detected vehicle, and transmits the generated violation item information to the vehicle terminal 50 (Step 14). The violation information transmitter/receiver 23 determines whether or not it receives reply information including the reception check message from the vehicle terminal 50 (Step 15). The violation information transmitter/receiver 23 repeatedly transmits the violation information until it receives the reply information.

The violation information transmitter/receiver 23 determines whether or not an expiration date of payment of the penalty notice arrives (Step 16). When the expiration date of the payment arrives, the violation information transmitter/receiver 23 again transmits the violation information to the vehicle terminal 50.

FIG. 4 is a flowchart illustrating a method for receiving and transmitting the violation information in the vehicle terminal according to the present invention. The wireless transmitter/receiver 51 of the vehicle terminal 50 receives the violation information from the violation information transmitter/receiver 23 of the competent authority server 20. The reception checking unit 52 determines whether or not the wireless transmitter/receiver 51 receives the violation information (Step 21). When it is determined to receive the violation information, the reception checking unit 52 generates the reply information including the reception check message, and transmits the generated reply information to the competent authority server 20 through the wireless transmitter/receiver 51 (Step 22).

Next, the recognizer controller 53 generates and outputs a driver recognizer control code to the driver recognizer 54 to the traffic regulation violation item information received through the wireless transmitter/receiver 51, to the driver (Step 23). After that, the driver recognizer 54 visually and aurally transmits the violation item information to the driver using the speaker and the display unit, depending on the control code received through an interface unit (Step 24).

As described above, in the present invention, upon violation of the traffic regulations, the driver of the violation vehicle detected by the sensor receives the regulation violation item from the competent authority through the vehicle terminal, and visually and aurally receives the violation content, thereby exactly recognizing the regulation violation and at the same time, preventing a recurrence of the regulation violation. Thus, the present invention can make a traffic operation smooth and prevent accidents, and reduce a public grievance relating to the enforcement.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A system for reporting a regulation violation of a vehicle, the system comprising:
a sensor for sensing the regulation violation of the vehicle;
a competent authority server for reading sense information received from the sensor, issuing a penalty notice, and transmitting regulation violation information to the violation vehicle;
a vehicle database for storing a variety of information relating to the vehicle;
a relay wire/wireless connecting with the competent authority server and at the same time, wireless connecting with a vehicle terminal; and
the vehicle terminal installed in the vehicle, and receiving the regulation violation information from the competent authority server and transmitting the received regulation violation information to a driver.

2. The system according to claim 1, wherein the sensor further comprises:
a regulation violation sensor for sensing the traffic regulation violation of the vehicle and at the same time, storing vehicle information; and
a sense information transmitter for transmitting a traffic regulation violation content and the vehicle information to the competent authority server through a wire/wireless communication network or a dedicated line.

3. The system according to claim 1, wherein the competent authority server further comprises:
a sense information receiver for receiving data having the traffic regulation violation content and the vehicle information transmitted by the sensor;
a regulation violation reader for receiving a traffic regulation violation item of a specific vehicle from the sensor and reading the received regulation violation item of the specific vehicle;
a violation information transmitter/receiver for transmitting a signal having information on the violation item that is decided on the basis of the read result of the regulation violation reader, to the violation vehicle, and receiving a reply signal having the reception check message from the violation vehicle; and
a notice issuing unit for, when it is decided to be the traffic regulation violation as the read result of the regulation violation reader, automatically reading the vehicle information, and issuing the penalty notice.

4. The system according to claim 1, wherein the vehicle terminal further comprises:
a wireless transmitter/receiver for receiving traffic regulation violation item information from the competent authority server and at the same time, again transmitting a reception check message to the competent authority server;
a reception checking unit for generating the reception check message;
a recognizer controller for controlling a driver recognizer to transmit the traffic regulation violation item information received through the wireless transmitter/receiver, to the driver; and
the driver recognizer for visually and aurally transmitting the traffic regulation violation item information to the driver under control of the recognizer controller.

5. A method for reporting a regulation violation of a vehicle, the method comprising steps of:
in a sensor, sensing and transmitting a regulation violation of a specific vehicle to a competent authority server;
in the competent authority server, receiving and reading regulation violation sense information;
in the competent authority server, automatically issuing a penalty notice depending on its regulation violation decision content;
in the competent authority server, transmitting regulation violation information data to the vehicle terminal; and
in a vehicle terminal, receiving the regulation violation information data, and aurally or visually transmitting the received information data to a driver.

6. The method of claim 5, wherein the receiving and reading further comprises a step of, in the competent authority server, reading the regulation violation sense information, and storing a read content in a vehicle information database.

7. The method of claim 5, wherein the transmitting of the regulation violation information data further comprises a step of, in the competent authority server, transmitting the regulation violation information data to the vehicle terminal, and repeatedly transmitting the regulation violation information data until receiving a reception check message from the vehicle terminal.

8. The method of claim 5, wherein the transmitting of the regulation violation information data further comprises a step of, in the competent authority server, transmitting the regulation violation information data to the vehicle terminal, determining whether or not an expiration date of payment of the penalty notice arrives, and, upon arrival of the expiration date of the payment, re-transmitting the regulation violation information data.
